(19) United States
(12) Patent Application Publication
(10) Pub. No.: US 2003/0078319 A1
(43) Pub. Date: Apr. 24, 2003

(54) Stabilizers for non-aqueous inks

(76) Inventors: Ryszard Sprycha, Wallington, NJ (US); Mathew C. Mathew, Bloomfield, NJ (US); Ramasamy Krishnan, Colonia, NJ (US)

Correspondence Address: SUN CHEMICAL COPORATION, 222 BRIDGE PLAZA SOUTH, FORT LEE, NJ, 07024, US

(21) Appl. No.: 09/982,496

(22) Filed: Oct. 18, 2001

(51) Int. Cl. C03C 17/00; C09D 5/00

(52) U.S. Cl. 523/160; 523/161

(57) ABSTRACT

A non-aqueous ink formulation or dispersion is disclosed containing a resin, a pigment, an organic solvent and a water-soluble base aminoalcohol, acid or aminoacid. Also disclosed is a method of increasing the stability and resolubility of non-aqueous inks formulations or dispersions by adding to the formulation or dispersion a small amount of water-soluble base aminoalcohol, acid or aminoacid.

### FIELD OF THE INVENTION

This invention relates to non-aqueous ink formulations or dispersions containing a water soluble base or acid that help in increasing stability and resolubility.

### BACKGROUND OF THE INVENTION

Hot melt polyamide systems are high performance inks which yield high bond strength on a variety of packaging substrates. At the same time, such inks give extremely low solvent retention. The very significant disadvantage in using these inks is that they suffer from poor stability, rheology and resolubility in particular red inks.

### SUMMARY OF THE INVENTION

The present invention provides a non-aqueous ink formulation or dispersion comprising: (a) a resin; (b) a pigment; (c) an organic solvent; and (d) a water-soluble compound selected from the group consisting of base, aminoalcohol, acid and aminoacid.

The present invention also provides a method of increasing the stability and resolubility of non-aqueous inks formulations or dispersions containing (a) a resin; (b) a pigment; (c) an organic solvent, comprising adding to said formulation or dispersion a water-soluble compound selected from the group consisting of base, aminoalcohol, acid and aminoacid.

### DETAILED DESCRIPTION OF THE INVENTION

It has now surprisingly been found that small amounts of water-soluble acids such as citric acid or aminoacids such as paraaminobenzoic acid or water-soluble bases such as sodium hydroxide or aminoalcohols such as amino-methyl propanol can greatly improve stability, rheology and resolubility of non-aqueous ink formulations or dispersions, in particular laminating inks.

Preferably, the resin present in the formulations of the present invention is polyamide resin, more preferably, a hot melt polyamide resin. Also preferably, the pigment present in the formulations of the present invention is selected from the group consisting of monoazo yellow, monoarylide yellow, diarylide yellow, naphthol red, rubine red, lithol rubine, phtalocyanine blue and carbon black. Also preferably, the organic solvent is selected from the group consisting of ethanol, n-propanol, iso-propanol, butanol, and propyl acetate.

Preferably, the amount of the water-soluble base or acid used in the present invention is about 0.01 to 5.0%, more preferably about 0.1 to 1.0% by weight of the total weight of the formulation or dispersion.

The water-soluble base may be an inorganic or organic base. Examples of inorganic bases suitable for the present invention include but are not limited to sodium hydroxide, potassium hydroxide and ammonium hydroxide. Suitable organic bases include amines and aminoalcohols. The amine is preferably selected from the group consisting of monoethanolamine, triethanolamine, dimethylethanolamine and diethylenetriamine while the aminoaclohol is preferably selected from the group consisting of aminopropanol, aminoethylpropanediol, aminobutanol, diethylaminoethanol and dimethylaminopropanol.

The water-soluble acid may be an organic or inorganic acid. Examples of inorganic acids include but are not limited to hydrochloric acid, nitric acid and sulfuric acid. Examples of organic acids include acetic acid, citric acid and paraaminobenzoic acid.

A typical commercial formulation of a hot melt polyamide system consists by weight % of:

| | |
|---|---|
| Hot melt polyamide resin | 10.6% |
| Low molecular weight | 3.0% |
| polyamide resin | |
| n-propanol | 71.4% |
| Pigment | 15.0% |
| Total | 100.0% |

The stability and resolubility of such a commercial formulation are deemed to be poor.

### EXAMPLE I

A red laminating ink was formulated as follows

| Component | % by weight |
|---|---|
| Hot melt polyamide resin I | 10.6% |
| Low molecular weight | 3.0% |
| polyamide resin | |
| Lithol Rubine red pigment | 15.0% |
| n-propanol | 70.7% |
| Amino-methyl-propanol | 0.7% |

Resolubility was evaluated visually. If after resolubilization dispersion contained only small flakes of dry ink film, resolubility was rated poor (−−−−−). When the dispersion after resolubilization was completely free of flakes or any aggregates the resolubility was rated excellent (+++++).

Stability was evaluated rheologically. If the viscosity of the formulation does not increase by more than 5 seconds (Zahn #2 cup) in overnight test at 50° C. the stability is considered good.

The stability and resolubility of this formulation was rated as very good.

### EXAMPLE II

A red laminating ink was formulated as follows:

| Component | % by weight |
|---|---|
| Hot melt polyamide resin II | 10.6% |
| Low molecular weight | 3.0% |
| polyamide resin | |
| Lithol Rubine red pigment | 15.0% |
| n-propanol | 70.8% |
| Citric acid | 0.6% |

The stability and resolubility were evaluated visually as described in Example I. The resolubility and stability of this formulation were rated as very good.

### EXAMPLE III

A red laminating ink was formulated as follows:

| Component | % by weight |
|---|---|
| Hot melt polyamide resin I | 10.6% |
| Low molecular weight | 3.0% |
| polyamide resin | |
| Lithol Rubine red pigment | 15.0% |
| n-propanol | 71.25% |
| Sodium hydroxide | 0.15% |

The stability and resolubility were evaluated visually as described in Example I. The resolubility and stability of this formulation were rated as excellent.

### EXAMPLE IV

A red laminating ink was formulated as follows:

| | |
|---|---|
| Hot melt polyamide resin II | 10.6% |
| Low molecular weight | 3.0% |
| polyamide resin | |
| Lithol rubine red pigment | 15.0% |
| n-propanol | 70.7% |
| paraaminobenzoic acid | 0.7% |

The stability and resolubility were evaluated visually or described in Example I. The stability and resolubility of this formulation were rated as very good.

### EXAMPLE V

Bond strength of the laminating inks of Examples I-IV (applied to treated polypropylene films) was measured using Instron 4400 Tensile Tester. The results, along with the above resolubility data, are presented below:

| | | BOND | |
|---|---|---|---|
| | | STRENGTH | |
| | | (g/linear | |
| INK | RESOLUBILITY | inch) | STABILITY |
| Typical | Poor | 500-550 | Poor |
| Formulation | (− − − − −) | | |
| Example I | Very Good | 550-600 | Very Good |
| | (+ + + +) | | |
| Example II | Very Good | 550-600 | Very Good |
| | (+ + + +) | | |
| Example III | Excellent | 500-550 | Excellent |
| | (+ + + + +) | | |
| Example IV | Very good | 500-550 | Very Good |
| | (+ + + +) | | |

As seen, the addition of small amount of those water soluble chemicals to non-aqueous laminating inks had no negative effect on the bond strength.

Resolubility was evaluated visually. If after resolubilization dispersion contained only small flakes of dry ink film, resolubility was rated poor (−−−−−). When the dispersion after resolubilization was completely free of flakes or any aggregates the resolubility was rated excellent (+++++).

The invention has been described in terms of preferred embodiments thereof, but is more broadly applicable as will be understood by those skilled in the art. The scope of the invention is only limited by the following claims.

What is claimed is:

1. A non-aqueous ink formulation or dispersion comprising: (a) a resin; (b) a pigment; (c) an organic solvent; and (d) a water-soluble compound selected from the group consisting of base, aminoalcohol, acid and aminoacid.

2. The ink formulation or dispersion of claim 1, wherein the resin is a polyamide resin.

3. The ink formulation or dispersion of claim 1, wherein the pigment is selected from the group consisting of monoazo yellow, monoarylide yellow, diarylide yellow, naphtol red, rubine red, lithol rubine, phtalocyanine blue and carbon black.

4. The ink formulation or dispersion of claim 1, wherein the organic solvent is selected from the group consisting of ethanol, n-propanol, iso-propanol, butanol and propyl acetate.

5. The ink formulation or dispersion of claim 1, wherein the amount of the water soluble compound is about 0.01 to 5.0% by weight of the total weight of the formulation or dispersion.

6. The ink formulation or dispersion of claim 1, wherein the amount of the water soluble compound is about 0.1 to 1.0% by weight of the total weight of the formulation or dispersion.

7. The ink formulation or dispersion of claim 1, wherein the base is inorganic or organic base.

8. The ink formulation or dispersion of claim 7, wherein the inorganic base is selected from the group consisting of sodium hydroxide, potassium hydroxide and ammonium hydroxide

9. The ink formulation or dispersion of claim 7, wherein the organic base is amine.

10. The ink formulation or dispersion of claim 9, wherein the amine is selected from the group consisting of monoethanolamine, trieathanolamine, dimethylethanolamine and diethylenetriamine.

11. The ink formulation or dispersion of claim 1, wherein the aminoaclohol is selected from the group consisting of aminopropanol, aminoethylpropanediol, aminobutanol, diethylaminoethanol and dimethylaminopropanol.

12. The ink formulation or dispersion of claim 1, wherein the acid is organic or inorganic acid.

13. The ink formulation or dispersion of claim 12, wherein the inorganic acid is selected from the group consisting of hydrochloric acid, nitric acid and sulfuric acid.

14. The ink formulation or dispersion of claim 12, wherein the organic acid is selected from the group consisting of acetic acid, citric acid, and paraaminobenzoic acid.

15. A method of increasing the stability and resolubility of non-aqueous inks formulations or dispersions containing (a) a resin; (b) a pigment; (c) an organic solvent, comprising adding to said formulation or dispersion a water-soluble compound selected from the group consisting of base, aminoalcohol, acid and aminoacid.

16. The method of claim 15, wherein the resin is a polyamide resin.

17. The method of claim 15, wherein the pigment is selected from the group consisting of monoazo yellow, monoarylide yellow, diarylide yellow, naphtol red, rubine red, lithol rubine, phtalocyanine blue and carbon black.

18. The method of claim 15, wherein the organic solvent is selected from the group consisting of n-propanol, iso-propanol, butanol, ethanol and propyl acetate.

19. The method of claim 15, wherein the amount of the water soluble compound is about 0.01 to 5.0% by weight of the total weight of the formulation or dispersion.

20. The method of claim 15, wherein the amount of the water soluble compound is about 0.1 to 1.0% by weight of the total weight of the formulation or dispersion.

21. The method of claim 15, wherein the base is inorganic or organic base.

22. The method of claim 21, wherein the inorganic base is selected from the group consisting of sodium hydroxide, potassium hydroxide and ammonium hydroxide

23. The method of claim 21, wherein the organic base is amine or aminoalcohol.

24. The method of claim 23, wherein the amine is selected from the group consisting of monoethanolamine, trieathanolamine, dimethylethanolamine and diethylenetriamine.

25. The method of claim 15, wherein the aminoaclohol is selected from the group consisting of aminopropanol, aminoethylpropanediol, aminobutanol, diethylaminoethanol and dimethylaminopropanol.

26. The method of claim 15, wherein the acid is organic or inorganic acid.

27. The method of claim 26, wherein the inorganic acid is selected from the group consisting of hydrochloric acid, nitric acid and sulfuric acid.

28. The method of claim 26, wherein the organic acid is selected from the group consisting of acetic acid, citric acid and paraaminobenzoic acid.
